(19) United States
(12) Patent Application Publication
(10) Pub. No.: US 2026/0210734 A1
(43) Pub. Date: Jul. 23, 2026

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: Ayato Imai, Tokyo (JP)

(21) Appl. No.: 19/551,486

(22) Filed: Feb. 26, 2026

Related U.S. Application Data
(63) Continuation of application No. 17/354,936, filed on Jun. 22, 2021.

(30) Foreign Application Priority Data
Jun. 25, 2020 (JP) 2020-109844

(51) Int. Cl. G01C 22/02; G01C 21/26; G01C 21/32; G01C 21/34; G01C 21/36

(52) U.S. Cl. CPC G01C 22/02; G01C 21/265; G01C 21/32; G01C 21/3484; G01C 21/3623

(57) ABSTRACT

An information processing apparatus performs first correction for correcting, in a case where a loop of a movement path of a sensor is detected, a position and orientation associated with a first measurement point used for estimation of a position and orientation to a position and orientation based on a second measurement point that is present near the sensor when the loop is detected.

### CROSS REFERENCE OF RELATED APPLICATIONS

This application is a continuation of U.S. patent application Ser. No. 17/354,936, Jun. 22, 2021, which claims the benefit of Japanese Patent Application No. 2020-109844, filed Jun. 25, 2020, which is hereby incorporated by reference herein in its entirety.

### BACKGROUND

### Field of the Disclosure

The present disclosure relates to a technique for estimating a position and orientation of a sensor and generating an electronic map for use in the estimation.

### Description of the Related Art

An autonomous moving body, such as an automated guided vehicle (AGV), is used in a factory or distribution warehouse. As a method for estimating the position and orientation of such an AGV and creating electronic environmental map data for use in the estimation, a Simultaneous Localization and Mapping (SLAM) technique using a camera or a laser range scanner as a sensor is known.

Mur-Artal, R., & Tardos, J. D. ORB-SLAM2: an Open-Source SLAM System for Monocular, Stereo and RGB-D Cameras. IEEE Transactions on Robotics 33 (5) 1255-1262 discusses a technique in which a computer recognizes the correspondence between a position in a real space and a measurement point on environmental map data based on information about each measurement point acquired by a sensor in processing for generating environmental map data by moving a moving body on which the sensor is mounted. The above-described prior art document also discusses a loop closing technique for correcting any one of positions and orientations in environmental map data based on the correspondence between a position in a real space and a measurement point recognized by a computer.

In the method discussed by Mur-Artal, R., & Tardos, J. D. ORB-SLAM2: an Open-Source SLAM System for Monocular, Stereo and RGB-D Cameras. IEEE Transactions on Robotics 33 (5) 1255-1262, it takes a long time to correct environmental map data when loop closing is performed, which leads to deterioration in the accuracy of position/orientation estimation. Specifically, if a sensor is continuously moving after correction processing is started, a new measurement point that is effected by errors accumulated before the correction processing is completed can be generated. In this case, the position/orientation estimation result can vary depending on whether the position and orientation are estimated based on a new measurement point, or whether the position and orientation are estimated based on the existing measurement point.

### SUMMARY

An information processing apparatus including one or more processors, wherein the one or more processors function as an acquisition unit configured to acquire sensor information obtained by measuring a surrounding environment and output from a sensor configured to move, a generation unit configured to generate map data indicating a map based on a movement path of the sensor, the map data including a measurement point where the sensor information is associated with a position and orientation of the sensor, an estimation unit configured to estimate the position and orientation of the sensor based on the sensor information acquired by the acquisition unit and the measurement point, a detection unit configured to detect a first measurement point included in the map data based on an output from the sensor, a first correction unit configured to correct, in a case where the first measurement point is detected by the detection unit, a position and orientation that are associated with a second measurement point used by the estimation unit to estimate the position and orientation and are included in the map data to a position and orientation based on the first measurement point, and a second correction unit configured to correct, in a case where the first measurement point is detected by the detection unit, positions and orientations that are included in the map data and are associated with a plurality of measurement points including a measurement point different from the second measurement point, a number of the plurality of measurement points being larger than a number of measurement points corrected by the first correction unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a movement path of a moving body and a state of an environmental map before correction processing is performed according to one or more aspects of the present disclosure.

FIG. 2 is a diagram illustrating an example of the state of the environmental map in a case where first correction processing is not performed according to one or more aspects of the present disclosure.

FIG. 3 is a diagram illustrating an example of the state of the environmental map after the first correction processing is performed according to one or more aspects of the present disclosure.

FIG. 4 is a diagram illustrating an example of the state of the environmental map before second correction processing is performed according to one or more aspects of the present disclosure.

FIG. 5 is a diagram illustrating an example of the state of the environmental map after the second correction processing is performed according to one or more aspects of the present disclosure.

FIG. 6 is a block diagram illustrating a configuration of a moving body system according to one or more aspects of the present disclosure.

FIG. 7 is a block diagram illustrating a logical configuration of an information processing apparatus according to one or more aspects of the present disclosure.

FIG. 8 is a block diagram illustrating details of a logical configuration of a loop closing processing unit according to one or more aspects of the present disclosure.

FIG. 9 is a flowchart illustrating an information processing flow according to one or more aspects of the present disclosure.

FIG. 10 is a flowchart illustrating details of a loop closing processing flow according to one or more aspects of the present disclosure.

FIG. 11 is a flowchart illustrating details of a first correction processing flow according to one or more aspects of the present disclosure.

FIG. 12 is a flowchart illustrating an information processing flow according to one or more aspects of the present disclosure.

FIG. 13 is a diagram illustrating an example of a state of an environmental map before first correction processing is performed according to one or more aspects of the present disclosure.

FIG. 14 is a flowchart illustrating details of a first correction processing flow according to one or more aspects of the present disclosure.

FIG. 15 is a diagram illustrating an example of the state of the environmental map after correction processing using rigid transformation is performed according to one or more aspects of the present disclosure.

FIG. 16 is a diagram illustrating an example of the state of the environmental map after feature point integration processing is performed according to one or more aspects of the present disclosure.

### DESCRIPTION OF THE EMBODIMENTS

An exemplary embodiment for preventing generation of redundant measurement points that is caused by the long processing time for correcting map data when loop closing is performed will be described below.

Exemplary embodiments will be described in detail below with reference to the drawings. The following exemplary embodiments are not intended to limit the scope of the claims of the present disclosure, and not all combinations of features described in the following exemplary embodiments are essential to the present disclosure.

A moving body system, an environmental map creation system, an information processing apparatus, an information processing method, and a computer program according to a first exemplary embodiment will be described in detail below with reference to the drawings.

The first exemplary embodiment illustrates an example where a moving body on which a sensor is mounted is externally operated by a user to move in an environment and environmental map data that can be used for position/orientation estimation and autonomous traveling of the moving body is generated. While the present exemplary embodiment illustrates an example where a grayscale camera is used as the sensor, the present exemplary embodiment is not limited to this example. For example, a compound-eye camera may also be used as the sensor and a depth may be used as sensor information. A laser range scanner, a laser range finder, Laser Imaging Detection and Ranging (LIDAR), or the like may also be used as the sensor.

The term “environment” used in the present exemplary embodiment refers to a three-dimensional space including an area in which the sensor moves and a surrounding area. The “position and orientation” used in the present exemplary embodiment are values with six degrees of freedom as a combination of three-dimensional position information and orientation information with three degrees of freedom. In the present exemplary embodiment, the position and orientation in the three-dimensional space can be represented by an affine matrix of 4 4, and only rotation and parallel translation in the properties of affine transformation are used. If two affine matrices A and B each representing a position and orientation are present, an affine matrix d representing a relative position and orientation (position/orientation difference) between the affine matrix A and the affine matrix B can be obtained by adding the affine matrix B to an inverse matrix of the affine matrix A. Similarly, the position/orientation B can be obtained by adding the relative position and orientation d to the position/orientation A.

### (Environmental Map Data)

Environmental map data for use in calculation of the position and orientation according to the present exemplary embodiment includes one or more measurement points and a pose graph. Each measurement point includes sensor information (image data captured by the sensor) and position/orientation information as information for position/orientation measurement and information for loop detection.

The pose graph is a simple graph in which measurement points are illustrated as nodes and a relative position and orientation between two measurement points are illustrated as edges. In the pose graph, each measurement point is connected to one or more other measurement points with edges. All measurement points on environmental map data are connected on the pose graph.

### (Drift and Loop Closing)

A relationship between an error (drift) in position and orientation that occurs when environmental map data is generated and loop closing processing will now be described. The environmental map data is generated by repeatedly generating a measurement point and estimating the current position and orientation using the measurement point. Accordingly, an error in position and orientation that has occurred when a measurement point is generated leads to an error in subsequent position/orientation estimation using the measurement point, so that errors are accumulated every time a measurement point is generated. The accumulation of errors is called a “drift.”

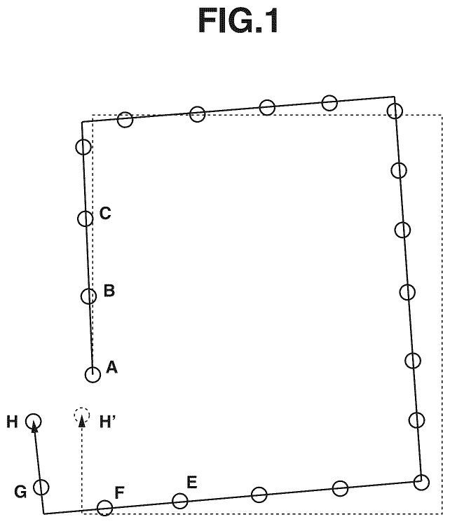

FIG. 1 is a diagram schematically illustrating a relationship between measurement points generated in environmental map data and a true movement path of the moving body on a plane. In FIG. 1, a solid line represents an estimated position and orientation of the moving body obtained by estimation results, and a dotted line represents a true position and orientation path of the moving body. In FIG. 1, each white circle represents a measurement point. The moving body generates measurement points B, C, . . . , E, F, G, and H while moving clockwise in the environment from the measurement point A as a start point, and then returns to a position near the measurement point A. A measurement point H′ represents a true position and orientation when the measurement point H is generated. A phenomenon in which an error in position and orientation that has occurred at each measurement point is accumulated and the position and orientation gradually deviate from the true position and orientation depending on the amount of movement is referred to as a drift.

To correct the drift, processing called “loop closing” is performed as follows. That is, the position and orientation of a moving body and an element on environmental map data are corrected when the moving body repeatedly reaches (loops) a certain point on the environmental map data. In loop closing processing, when the sensor detects that the moving body has returned to an already mapped area (loop detection), errors accumulated by search are corrected (loop correction). In the example illustrated in FIG. 1, the position and orientation at each measurement point on a path from the measurement point A to the measurement point H are corrected (pose graph optimization) so as to correct the position and orientation at the measurement point H to substantially correspond to the measurement point H′ and to satisfy a relative position/orientation relationship between the corrected measurement point and the other measurement points.

However, in the pose graph optimization, positions and orientations at a large number of measurement points on the environmental map data are used as parameters. Accordingly, it takes a longer time depending on the number of measurement points. Therefore, if the moving body is continuously moving when the pose graph optimization is performed after a loop is detected, a new measurement point can be generated before the pose graph optimization is completed.

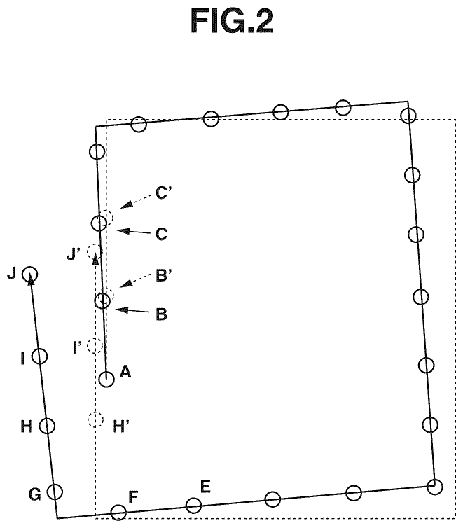

FIG. 2 is a diagram illustrating a state of environmental map data in the above-described situation. After the measurement point H is generated, a loop is detected between the measurement points A and H. The moving body is continuously traveling through positions apart from the measurement points A and B on the environmental map data, so that new measurement points I and J are generated before the pose graph optimization processing is completed. The positions and orientations at the measurement points I and J are corrected to measurement points I′ and J′, respectively, after the pose graph optimization processing is completed. However, the measurement points I′ and J′ are not connected to measurement points A′, B′, and C′ that are present in the vicinity of the measurement points I′ and J′ after correction on the pose graph. Therefore, if the moving body further moves forward from the measurement point J′, another new measurement point can be generated in the vicinity of the measurement point C′. If the moving body travels near these measurement points again and the position and orientation are calculated, the position/orientation estimation result can vary depending on whether the position and orientation are calculated with reference to the measurement points B′ and C′, or whether the position and orientation are calculated with reference to the measurement points I′ and J′.

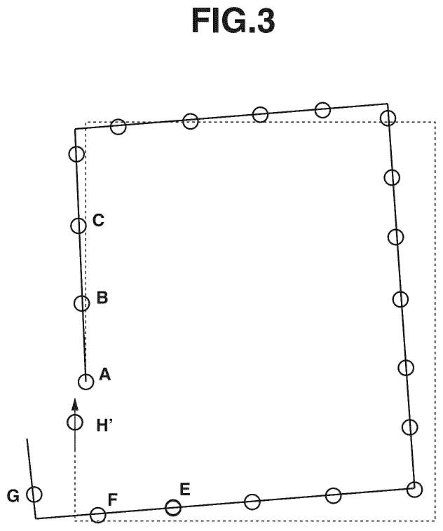

To avoid the issue, in the present exemplary embodiment, at a timing when a loop is detected between the measurement points A and H, local correction processing that can be completed for a short period of time is performed on the measurement point H that is used to measure the position and orientation of the moving body. FIG. 3 is a diagram illustrating a state of environmental map data when local correction processing is finished. The position and orientation at the measurement point H is corrected to a measurement point H′. In the present exemplary embodiment, the moving body is still located near the measurement point H′ at this point and a new measurement point is not generated.

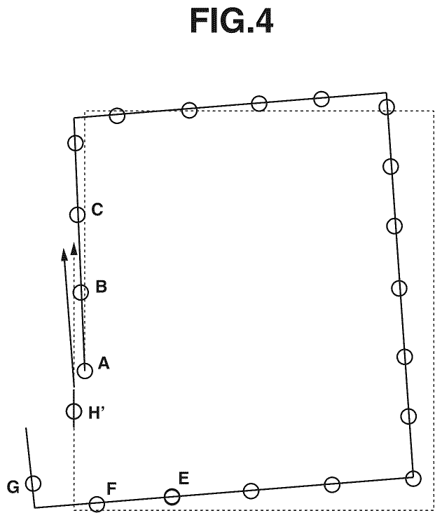

FIG. 4 is a diagram illustrating a state where the moving body is continuously moving forward on a course along the measurement points A and B before the pose graph optimization processing is completed after the local correction processing is finished. At this time, in the present exemplary embodiment, the position and orientation of the moving body can be calculated with reference to the measurement points A and B, so that new measurement points corresponding to the measurement points I and J are thus not generated.

At this point, since a drift in the position and orientation at the measurement point B is not corrected, the path of the moving body obtained by the position/orientation estimation results after a loop is detected exhibits an error in a leftward direction in FIG. 4 due to the measurement point B. However, the amount of this error is smaller than the amount of error caused by the drift at the measurement point H. Also, the relative position/orientation relationship between the path when the measurement point B is generated and the path after a loop is detected is maintained at this point.

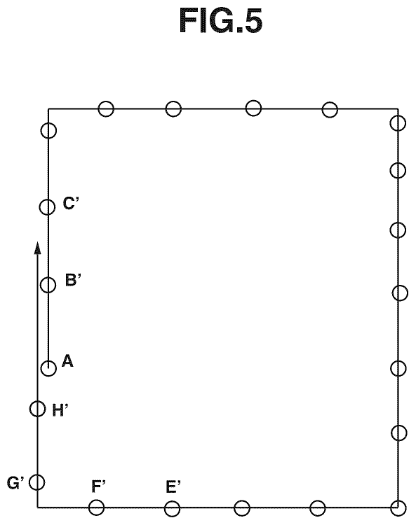

FIG. 5 is a diagram illustrating a state when the pose graph optimization processing is completed. The pose graph optimization processing enables the position and orientation at the measurement points B to G to be corrected to measurement points B′ to G′, respectively, which are located near the true movement path. At this point, the position and orientation of the moving body are also corrected based on the measurement point B.

Thus, in the present exemplary embodiment, local correction processing that is completed in a short period of time is performed prior to the pose graph optimization. Thus, even if it takes a long time for pose graph optimization, it is possible to prevent generation of redundant measurement points and to prevent deterioration in the accuracy of position/orientation estimation when environmental map data is used. According to the present exemplary embodiment, in Simultaneous Localization and Mapping (SLAM), when a loop is detected, local position/orientation correction processing, which is completed in a short period of time with a smaller amount of processing than that in the pose graph optimization processing, is performed on only a loop source or the like before the pose graph optimization is performed and before a new measurement point is generated. Thus, it is possible to prevent generation of measurement points that should not be generated based on an error in environmental map data and to prevent deterioration in the accuracy of the position/orientation estimation result due to measurement points generated based on such an error.

### (Configurations of Moving Body System, Environmental Map Creation System, and Information Processing Apparatus)

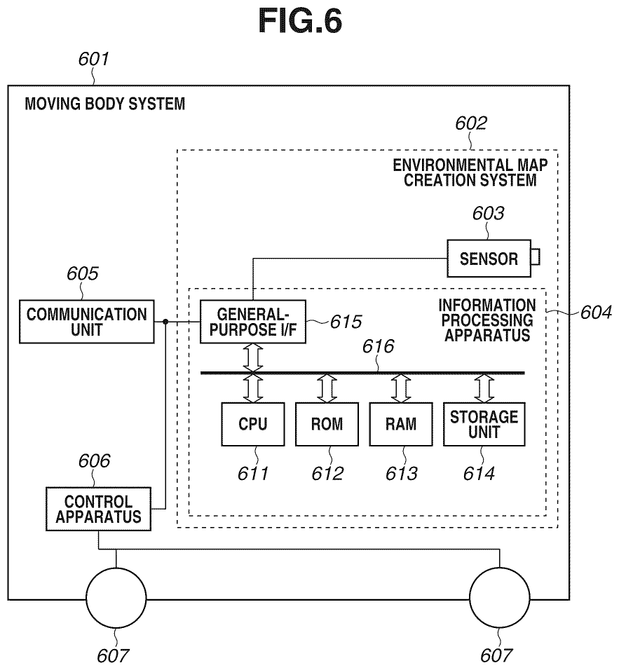

Next, a configuration example of a moving body system 601 according to the present exemplary embodiment will be described with reference to FIG. 6. The moving body system 601 includes an environmental map creation system 602 that includes a sensor 603 and an information processing apparatus 604, a communication unit 605, a control apparatus 606, and moving units 607.

The sensor 603 outputs sensor information obtained by measuring a surrounding environment. The sensor 603 is a camera that is fixed in a front direction of the moving body system 601 and configured to successively acquire grayscale luminance images. To simplify the explanation, assume that internal parameters, such as a focal length and an angle of view of the camera, are known and an image is output in a state where the image has no distortion or the distortion in the image is corrected. The sensor 603 captures images 30 times per second, but instead may capture images at other frame rates.

The information processing apparatus 604 estimates the position and orientation of the moving body system 601 and generates environmental map data based on information input from the sensor 603. During autonomous traveling of the moving body system 601, the information processing apparatus 604 issues a movement instruction to the control apparatus 606. The configuration of the information processing apparatus 604 will be described in detail below.

The communication unit 605 receives instructions from the user, such as an instruction for movement or rotation of the moving body system 601 and an instruction for starting or finishing environmental map creation processing to be performed by the information processing apparatus 604. The communication unit 605 is, for example, a chip or an antenna for establishing communication based on the Institute of Electrical and Electronics Engineers (IEEE) 802.11 series. The communication method for the communication unit 605 is not limited to the IEEE 802.11 series. Other communication methods such as Bluetooth® or wired communication may also be used.

The control apparatus 606 controls driving of the moving units 607. The control apparatus 606 drives the moving units 607 based on instructions from the information processing apparatus 604 and the communication unit 605 to causes the moving body system 601 to move or rotate. The moving units 607 are a plurality of tires that partially or entirely operate with power.

### (Configuration of Information Processing Apparatus)

The information processing apparatus 604 includes functions of a general built-in personal computer (PC) apparatus. The information processing apparatus 604 includes a central processing unit (CPU) 611, a read-only memory (ROM) 612, a random access memory (RAM) 613, a storage unit 614, such as a hard disk drive (HDD) or solid-state drive (SSD), a general-purpose interface (I/F) 615, such as a universal serial bus (USB), and a system bus 616.

The CPU 611 executes an operating system (OS) and various computer programs stored in the ROM 612 and the storage unit 614 using the RAM 613 as a work memory, thereby calculating or processing information and controlling each unit via the system bus 616. For example, programs to be executed by the CPU 611 include programs for executing processing to be described below.

The sensor 603, the communication unit 605, and the control apparatus 606 are each connected to the information processing apparatus 604 via the general-purpose I/F 615.

FIG. 6 illustrates an example where the information processing apparatus 604 is incorporated in the moving body system 601. However, the configuration of the information processing apparatus 604 is not limited to this example. The information processing apparatus 604 may be configured as an apparatus separate from the moving body system 601. In this case, the general-purpose I/F 615 may operate as a wireless or wired communication interface, and may be configured to communicate with the communication unit 605 and communicate with the sensor 603 for data exchange. The information processing apparatus 604 may constitute the entire moving body system 601.

### (Logical Configuration of Information Processing Apparatus)

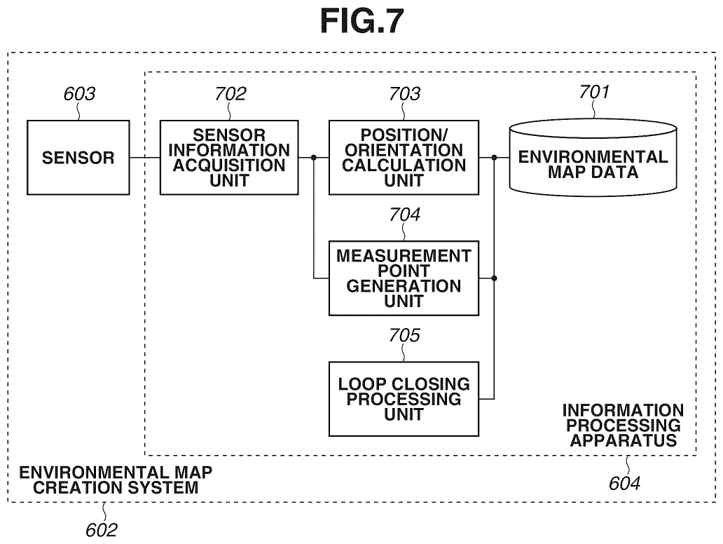

A logical configuration of the information processing apparatus 604 according to the present exemplary embodiment will be described below. Processing of each unit to be described below is executed as software in such a manner that a computer program is loaded from the ROM 612 or the like into the RAM 613 and the loaded program is executed by the CPU 611. FIG. 7 is a block diagram illustrating a logical configuration of the environmental map creation system 602 and the information processing apparatus 604. Each logical configuration illustrated in FIG. 7 may be configured as an application specific integrated circuit (ASIC), a field-programmable gate array (FPGA), or the like.

Environmental map data 701 is environmental map data that is stored on the RAM 613 and is currently created.

A sensor information acquisition unit 702 acquires an output from the sensor 603. Specifically the sensor information acquisition unit 702 acquires an image captured by the sensor 603.

A position/orientation calculation unit 703 selects a measurement point located in the vicinity of the sensor 603 from among the measurement points included in the environmental map data 701, and estimates the position and orientation of the sensor 603 based on the image captured by the sensor 603 and the selected measurement point.

A measurement point generation unit 704 adds a measurement point to the environmental map data 701, as needed, based on the image captured by the sensor 603 and the position/orientation information estimated by the position/orientation calculation unit 703. It may be desirable to add a measurement point, for example, when the distance between the position of the sensor 603 in the environmental map and the existing measurement point in the environmental map is more than or equal to a predetermined value and when it is determined that it is difficult to estimate the position and orientation based on the existing measurement points. Further, the measurement point generation unit 704 adds a relative position and orientation between the generated measurement point and the measurement point used for position/orientation estimation when the measurement point is generated to a pose graph on the environmental map data 701.

A loop closing processing unit 705 performs loop closing processing. When the sensor detects that a moving body has returned to an already mapped area (loop detection), the loop closing processing unit 705 corrects errors accumulated by search (loop correction). Specifically, when the loop closing processing unit 705 determines that the newly generated measurement point is located in the vicinity of the previously generated measurement point, the loop closing processing unit 705 calculates relative positions of the two measurement points and associates the measurement points on the pose graph. Then, the loop closing processing unit 705 performs processing for correcting the shape of at least an area constituting a loop on the environmental map. The configuration of the loop closing processing unit 705 will be described in detail below.

### (Logical Configuration of Loop Closing Processing Unit)

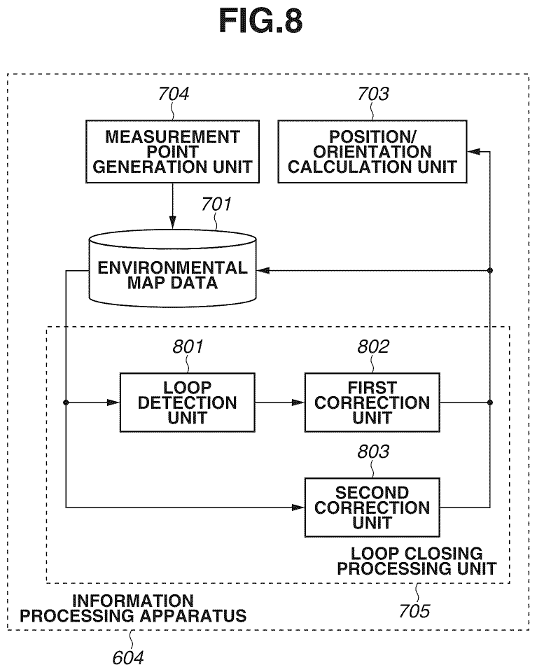

FIG. 8 is a block diagram illustrating a detailed logical configuration of the loop closing processing unit 705.

A loop detection unit 801 checks a newly generated measurement point on the environmental map data 701, and determines whether a loop of measurement points has occurred. The term “loop” used herein refers to a state where a newly generated measurement point and the previously created measurement point that is not associated on the pose graph are located close to each other in the real space. Specifically, first, a similarity between an image captured at a measurement point newly generated and an image captured at each measurement point already created is calculated by using a known Bag-of-Words (BoW) model, and a measurement point with a similarity that is greater than or equal to a certain level is extracted.

After that, the loop detection unit 801 calculates a relative position and orientation between the newly generated measurement point and each created measurement point in descending order of similarity. Specifically, image feature points are extracted from the sensor information about the both measurement points, and the relative position and orientation between images are estimated based on a distribution of feature points. If the calculation of the relative position and orientation at any one of the measurement points is successful, the loop detection unit 801 determines that a loop has occurred between the both measurement points. Hereinafter, a newly generated measurement point is referred to as a loop source, and a previously created measurement point is referred to as a loop destination. A path between the loop source and the loop destination on the pose graph before a loop is detected is referred to as a loop range.

A first correction unit 802 corrects position/orientation information about elements in the environmental map data 701, which is referred to by the position/orientation calculation unit 703, to the position and orientation based on the loop destination measurement point. Further, the first correction unit 802 adds the relative position and orientation between the loop source measurement point and the loop destination measurement point to the pose graph on the environmental map data 701.

A second correction unit 803 performs optimization processing (pose graph optimization) on position/orientation information about each measurement point illustrated in the pose graph on the environmental map data 701. The second correction unit 803 acquires the relative position and orientation between measurement points, and performs pose graph optimization to minimize an error between the relative position/orientation information between measurement points illustrated in the pose graph and the relative position/orientation information calculated based on the positions and orientations at measurement points.

### (Environmental Map Data Creation Processing)

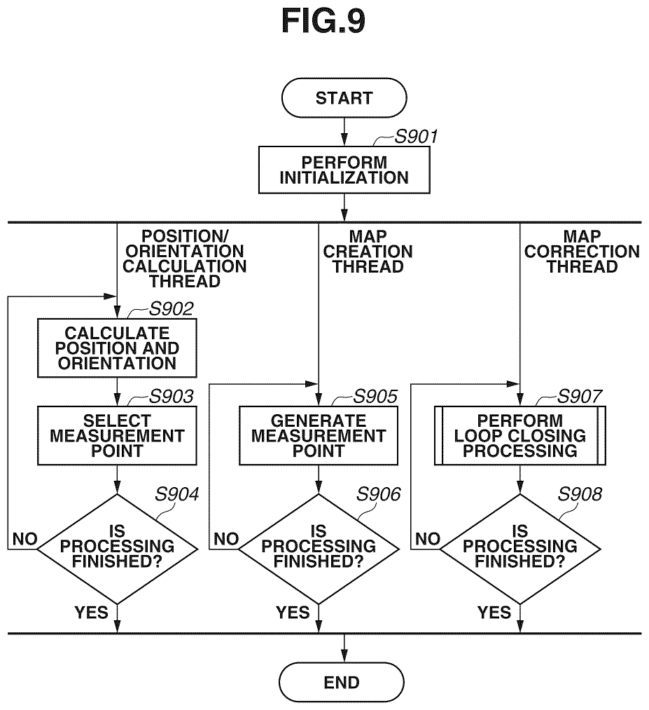

Next, a method for creating environmental map data relating to an information processing method using the information processing apparatus 604 according to the present exemplary embodiment will be described with reference to FIGS. 9 to 11. FIG. 9 is a flowchart illustrating an environmental map data correction processing flow according to the present exemplary embodiment. Processing illustrated in flowcharts of FIGS. 9 to 11 is implemented by the CPU 611 loading a program stored in the ROM 612 or the storage unit 614 and executing the program to calculate or process information and control each hardware module. Some or all of the steps illustrated in each flowchart may be implemented by a hardware module such as an ASIC or an FPGA.

As illustrated in FIG. 9, in step S901, the information processing apparatus 604 performs initialization. The information processing apparatus 604 constructs empty environmental map data 701, and generates a first measurement point (measurement point A illustrated in FIG. 1) on the environmental map data 701. The position of the first measurement point is set as an origin in the environment, and the orientation is set in a predetermined direction (e.g., Y-axis positive direction). The information processing apparatus 604 initializes the current position/orientation information estimated by the position/orientation calculation unit 703 with the position and orientation at the first measurement point.

The subsequent processing is executed in three threads, i.e., a position/orientation calculation thread, a map creation thread, and a map correction thread, in parallel. Steps S902 to S904 correspond to processing in the map creation thread.

In step S902, the position/orientation calculation unit 703 acquires an image from the sensor 603, and updates the current position/orientation information based on the image and the measurement point that is currently referred to. Specifically, the information processing apparatus 604 uses, as the current position/orientation information, position/orientation information obtained by applying a position/orientation difference between the image associated with the measurement point and the latest image captured at the current position to the position/orientation information associated with the measurement point that is currently referred to. The position/orientation difference between the images is estimated from a distribution of feature points on each of the images. To maintain the correspondence of feature points between the images, the feature points are tracked between the latest image and the previous image.

Instead of calculating the position/orientation difference from the image associated with the measurement point in each image, the position/orientation difference between the latest image and the previous image may be calculated and the calculated position/orientation difference may be repeatedly applied to the current position/orientation information.

For the above-described extraction of feature points on the image, Features from Accelerated Segment Test (FAST) algorithm is used in the present exemplary embodiment. To estimate the position/orientation difference between images, bundle adjustment processing is used to optimize only the position and orientation of the sensor 603 while the position of each feature point is fixed. The bundle adjustment processing is a method used for solving a problem to estimate a parameter for a geometrical model based on the correspondence relation of image feature points extracted between a plurality of images, and is also used for numerically solving a non-linear optimization problem. In the bundle adjustment processing, three-dimensional coordinates of each feature point are calculated based on the correspondence relation of feature points between input images. The calculated three-dimensional coordinates of each feature point are re-projected on an image plane, and a re-projection error calculated as a distance between a re-projection point and each feature point is repetitively re-estimated, thereby estimating more accurate values of three-dimensional coordinates of each feature point.

A known Kanade-Lucas-Tomasi (KLT) algorithm is used to track feature points between images. The algorithms used for feature point extraction and feature point tracking described above may be replaced by other algorithms.

In step S903, the position/orientation calculation unit 703 selects a measurement point to be referred to in the subsequent position/orientation calculation. Specifically, the information processing apparatus 604 selects a measurement point with the highest corresponding amount of the feature point with respect to the latest image from among the measurement points located near the current position and orientation on the environmental map data 701.

The position/orientation calculation unit 703 determines whether a new measurement point is to be added. If a new measurement point is to be added, the position/orientation calculation unit 703 issues an instruction to generate a measurement point to the measurement point generation unit 704. Specifically, if the corresponding amount of the feature point between the measurement point selected in step S903 and the latest image is less than or equal to a threshold, or if the difference between the position and orientation at the measurement point and the current position and orientation is more than or equal to the threshold, the information processing apparatus 604 determines that a new measurement point is to be added. If it is determined that a new measurement point is to be added and the measurement point generation unit 704 does not have any unprocessed measurement point generation instruction, the information processing apparatus 604 issues an instruction to generate a new measurement point in the map creation thread. In the instruction to generate a measurement point, the position/orientation calculation unit 703 delivers information about the selected measurement point and the latest image to the measurement point generation unit 704.

In step S904, it is determined whether to finish the processing in the position/orientation calculation thread. If the environmental map data creation processing is finished in response to an instruction from the user (YES in step S904), the thread is finished. If the environmental map data creation processing is not finished (NO in step S904), the processing returns to step S902 to repeat the processing.

Steps S905 and S906 are processing in the map creation thread.

In step S905, the measurement point generation unit 704 generates a new measurement point based on the instruction issued from the position/orientation calculation unit 703 in step S903. If the measurement point generation unit 704 has no unprocessed instruction, the measurement point generation unit 704 waits to receive a new instruction. The new measurement point includes information indicating the image acquired in step S902 and the position and orientation. The measurement point generation unit 704 acquires a captured image from the sensor 603, and calculates the position and orientation based on the captured image. The measurement point generation unit 704 then generates a measurement point including the acquired captured image and the calculated position and orientation.

Further, the measurement point generation unit 704 adds relative position/orientation information between the new measurement point and the measurement point selected in step S903 to the pose graph.

In step S906, it is determined whether to finish the processing in the map creation thread. If the position/orientation calculation thread is already finished (YES in step S906), the map creation thread is terminated. If the position/orientation calculation thread is not finished (NO in step S906), the processing returns to step S905 to repeat the processing.

Steps S907 and S908 are processing in the map correction thread.

Upon detecting a loop on the environmental map data on which the map creation thread is updated, in step S907, the information processing apparatus 604 performs loop closing processing. The loop closing processing will be described in detail below.

In step S908, it is determined whether to finish the map correction thread. If the position/orientation calculation thread and the map creation thread are already finished (YES in step S908), the map correction thread is terminated. If the position/orientation calculation thread and the map creation thread are not finished (NO in step S908), the processing returns to step S907 to repeat the processing.

### (Details of Loop Closing Processing)

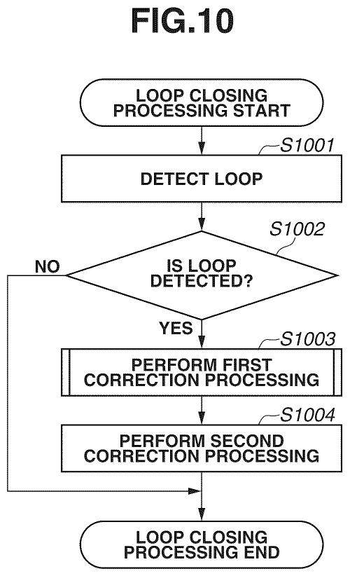

Next, the loop closing processing illustrated in step S907 will be described in detail. FIG. 10 is a flowchart illustrating a loop closing processing flow according to the present exemplary embodiment.

As illustrated in FIG. 10, in step S1001, the loop detection unit 801 detects a loop and calculates the relative position and orientation between the loop source measurement point and the loop destination measurement point. In step S1002, it is determined whether a loop is detected. If a loop is detected (YES in step S1002), the processing proceeds to S1003 after information about the relative position and orientation between the loop source and the loop destination is added to the pose graph. If no loop is detected (NO in step S1002), the loop closing processing is terminated.

In step S1003, the first correction unit 802 performs first correction processing to correct the position/orientation information about the measurement point that is currently referred to by the position/orientation calculation unit 703 to the coordinates based on the loop destination measurement point. The first correction processing is completed in a shorter period of time than the interval for generating a measurement point in the map creation thread. In other words, the information processing apparatus 604 does not generate any new measurement point during a period from when the first correction processing is started until when the first correction processing is completed. The first correction processing will be described in detail below.

In step S1004, the second correction unit 803 performs the pose graph optimization processing (second correction processing) on the loop range on the environmental map data 701 and the measurement point generated after the loop range. The information about the relative position/orientation between the loop source and the loop destination calculated in step S1001 is added to the pose graph in step S1003, and a drift that has occurred at each measurement point is corrected by the pose graph optimization processing. Consequently, the position and orientation at each measurement point can be corrected to a position close to the true position/orientation path of the sensor 603. If the position and orientation at the measurement point that is currently referred to by the position/orientation calculation unit 703 are corrected by the pose graph optimization processing, the current position/orientation information about the sensor 603 is also corrected.

### (Details of First Correction Processing)

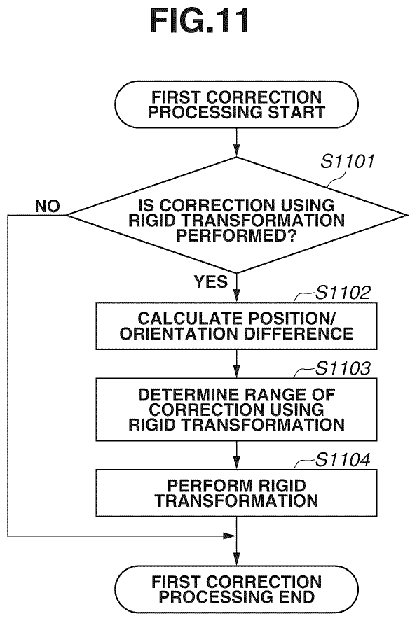

Next, the first correction processing illustrated in step S1003 will be described in detail with reference to a flowchart illustrated in FIG. 11. In this case, the position and orientation at each measurement point are corrected by rigid transformation using the position/orientation difference.

First, a case is considered where, as illustrated in FIG. 1, the sensor 603 generates the measurement points B, C, . . . , E, F, G, and H while moving clockwise in the environment from the measurement point A as a start point, and then the sensor 603 returns to a position near the measurement point A. In step S1001, a loop in which the measurement point H is set as a loop source and the measurement point A is set as a loop destination is detected, and the relative position and orientation between the measurement points are calculated.

As illustrated in FIG. 11, in step S1101, it is determined whether to perform correction processing using rigid transformation. The rigid transformation indicates transformation of only parallel translation and rotation.

As described above, the first correction processing is processing for correcting the position/orientation information about the measurement point that is currently referred to by the position/orientation calculation unit 703 to the coordinates based on the loop destination measurement point. Accordingly, if the position/orientation calculation unit 703 has already referred to the loop destination measurement point or the measurement point near the loop destination measurement point on the pose graph, the correction of the position and orientation at the measurement point using rigid transformation cannot be effectively operated. In the present exemplary embodiment, the distances between the measurement point that is currently referred to by the position/orientation calculation unit 703 and the loop source measurement point and the loop destination measurement point on the pose graph are compared. Only when the loop source measurement point is closer to the measurement point, the following processing of steps S1102 to S1104 is carried out.

In step S1102, the first correction unit 802 first calculates the relative position and orientation. After that, the position and orientation at the measurement point H′ after the first correction is calculated based on the position and orientation at the loop destination measurement point and the calculated relative position and orientation. Further, a position/orientation difference dH for use in the first correction is calculated based on the position and orientation at the measurement point H′ after correction and the position and orientation at the measurement point H before correction.

In step S1103, elements on the environmental map data on which the correction processing using rigid transformation is performed are selected. Assume herein that a period from when an instruction to generate the measurement point H is issued (step S903) to when a loop is detected (step S1001) is sufficiently short and that the sensor 603 is located near the measurement point H. Accordingly, the position/orientation calculation unit 703 is still referring to the measurement point H. In this case, the measurement point H is selected as a measurement point to be corrected.

In step S1104, the first correction unit 802 adds the position/orientation difference dH calculated in step S1102 to the correction target position and orientation selected in step S1103, and updates the position and orientation. The current position/orientation information about the sensor 603 is also updated in the same manner.

This processing can be implemented by integration of a simple matrix of 4×4, and can be completed in a much shorter period of time than the measurement point generation processing in step S905 or the processing of step S1004, which includes the pose graph optimization processing. Accordingly, after the loop closing processing unit 705 detects a loop, the correction processing is completed before it is necessary to generate a new measurement point in the position/orientation calculation thread, and then the position/orientation calculation processing in which the measurement point A is referred to can be performed. Consequently, it is possible to prevent generation of the redundant measurement points I and J.

Thus, when a loop is detected, the information processing apparatus 604 executes local correction processing prior to the pose graph optimization processing that is to correct the positions and orientations associated with a plurality of measurement points included in the environmental map data. The first correction processing performed as local correction processing corrects the positions and orientations at a fewer number of measurement points than the number of measurement points corrected in the pose graph optimization processing. In other words, when a loop is detected, the information processing apparatus 604 executes the first correction processing to correct the positions and orientations at some of the measurement points. After the first correction processing is completed, the information processing apparatus 604 completes the second correction processing on a larger number of measurement points than the number of measurement points corrected in the first correction processing. Thus, it is possible to prevent generation of redundant measurement points.

The present exemplary embodiment illustrates an example where the first correction unit 802 performs correction processing using rigid transformation. However, the correction processing is not limited to this example. The correction processing performed by the first correction unit 802 may be another correction processing as long as the amount of processing thereof is less than the amount of processing in the correction processing (pose graph optimization processing) performed by the second correction unit 803. Further, the correction processing performed by the first correction unit 802 may be another correction processing as long as, even when the sensor 603 is continuously moving after a loop is detected, the correction processing can be completed before a new measurement point is generated and the position and orientation at the loop source measurement point or at a measurement point near the loop source measurement point can be corrected.

### (Advantageous Effects of the Present Exemplary Embodiment)

As described above, according to the present exemplary embodiment, even when the environmental map correction processing is performed during creation of environmental map data, the environmental map data with which the position and orientation can be estimated with high accuracy can be generated. Further, according to the present exemplary embodiment, the first correction processing is completed prior to the second correction processing, thereby preventing generation of redundant measurement points which is caused an increase in time for correction of map data during loop closing processing.

The moving body system 601 moves to circulate through a plurality of coordinates while performing the position/orientation estimation processing based on the environmental map data generated by the information processing apparatus 604 and the image captured by the sensor 603, thereby traveling autonomously with high accuracy.

A second exemplary embodiment will be described below. The first exemplary embodiment described above illustrates an example where the position/orientation calculation unit 703 performs position/orientation measurement processing with reference to a single measurement point in the environmental map data 701. The present exemplary embodiment illustrates a method for correcting environment map data in a case where three-dimensional position information about each feature point in the environment is held as environmental map data and the moving body system 601 estimates position/orientation information based on a three-dimensional feature point distribution and sensor information. In the case of creating such environmental map data, the relative position and orientation between measurement points are corrected, as needed, by a method called bundle adjustment, thereby making it possible to generate environmental map data with higher accuracy.

### (Environmental Map Data)

The environmental map data for use in calculation of a position and orientation in the present exemplary embodiment includes a plurality of feature points in the environment, one or more measurement points, and a pose graph.

Each feature point in the environment includes three-dimensional position information. Each measurement point holds not only sensor information (image) and position/orientation information as information for feature point detection in the environment and information for loop detection, but also observation information about each feature point in the environment. The observation information is a list of combinations of a feature point in the environment of an image included in the sensor information and two-dimensional coordinates on the image. Two-dimensional coordinates on the image are information corresponding to the azimuth of each feature point in the environment as viewed from the sensor.

### (Configurations of Moving Body System, Environmental Map Creation System, and Information Processing Apparatus)

Physical and logical configurations of the moving body system 601 according to the present exemplary embodiment are similar to those of the first exemplary embodiment, and thus the descriptions thereof are omitted.

### (Environmental Map Data Creation Processing)

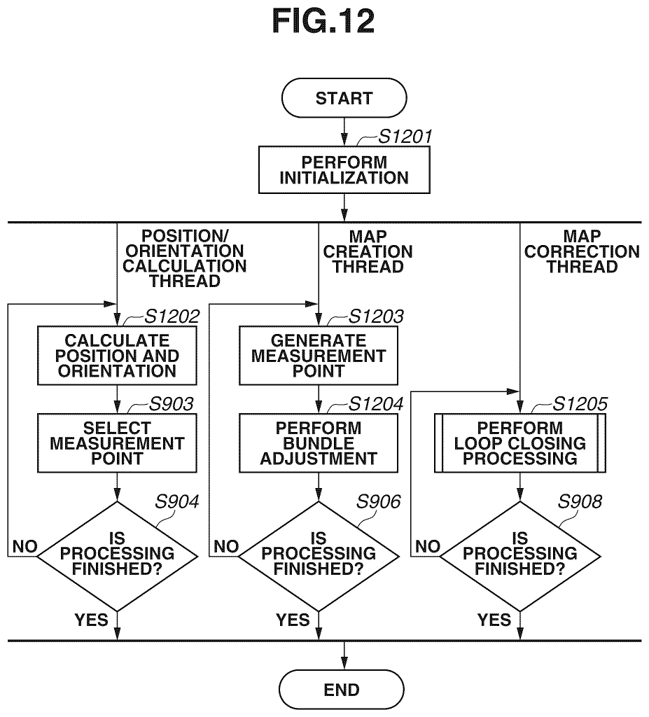

A method for creating environmental map data according to the present exemplary embodiment will be described with reference to FIGS. 12 to 16. FIG. 12 is a flowchart illustrating an environmental map data creation processing flow according to the present exemplary embodiment. Steps similar to the steps in the flowchart illustrated in FIG. 9 are denoted by the same numerals in the flowchart illustrated in FIG. 12, and the detailed descriptions thereof are omitted. Specifically, the processing of steps S903, S904, S906, and S908 is similar to that of the first exemplary embodiment, and thus the descriptions thereof are omitted.

As illustrated in FIG. 12, in step S1201, the information processing apparatus 604 performs initialization. The information processing apparatus 604 constructs empty environmental map data 701 and generates the first measurement point (measurement point A illustrated in FIG. 1) and a feature point group in the environment observed from the first measurement point on the environmental map data 701. The information processing apparatus 604 initializes the current position/orientation information estimated by the position/orientation calculation unit 703 with the position and orientation at the first measurement point. Like in the first exemplary embodiment, the position of the first measurement point is set as an origin in the environment and the orientation is set in the predetermined direction (e.g., positive Y-axis direction).

To generate a feature point group in the environment, first, images are acquired from the sensor 603 at two locations, i.e., at the position and orientation for generating the first measurement point A and at the position/orientation A′ that is slightly away from the first measurement point A. After that, three-dimensional coordinates of image feature points that match between images are estimated using bundle adjustment processing based on image feature points extracted from the images. Lastly, the image feature point for which the estimation of three-dimensional coordinates is successful is added to the environmental map data as a feature point in the environment, and two-dimensional coordinates of the image feature point on the image of the measurement point A corresponding to the feature point in the environment are added as observation information as viewed from the measurement point A.

The position/orientation calculation thread according to the second exemplary embodiment will be described.

In step S1202, the position/orientation calculation unit 703 acquires an image from the sensor 603, and updates the current position/orientation information based on the image and the feature point in the environment. The position/orientation calculation unit 703 re-projects the feature point in the environment observed from the measurement point referred to at this point on the image, and performs optimization processing to calculate the position and orientation such that a re-projection error between a re-projection point and the corresponding image feature point is minimized. In this case, the feature point is tracked between the latest image and the previous image so as to maintain the correspondence between the image and the feature point in the environment.

Further, steps S903 and S904 are carried out like in the first exemplary embodiment.

Next, the map creation thread according to the second exemplary embodiment will be described.

In step S1203, the measurement point generation unit 704 generates a feature point in the environment and a measurement point based on an instruction issued from the position/orientation calculation unit 703 in step S903.

The measurement point to be generated includes the image acquired in step S1202 and the position and orientation, the feature point group in the environment tracked by the position/orientation calculation unit 703, and observation information on the newly generated feature point group in the environment to be described below. The feature point in the environment is generated using the image of the measurement point selected in step S1202 and the captured image at the measurement point to be generated.

First, the information processing apparatus 604 extracts an image feature point that is not associated with the existing feature point in the environment from both images. After that, the information processing apparatus 604 estimates three-dimensional coordinates of the corresponding image feature point between the images based on the relative position and orientation between the images. Lastly, the information processing apparatus 604 adds the image feature point for which the estimation of three-dimensional coordinates is successful to the environmental map data as the feature point in the environment, and adds two-dimensional coordinates of the image feature point on each image corresponding to the feature point in the environment as observation information from each measurement point. Further, the measurement point generation unit 704 adds the relative position/orientation information between the new measurement point and the measurement point selected in step S903 to the pose graph.

In step S1204, the measurement point generation unit 704 performs bundle adjustment processing to corrects the measurement point generated in step S1202 and the positions and orientations of the measurement point group that shares the feature point in the environment. Further, the measurement point generation unit 704 adds or writes the relative position/orientation information between measurement points obtained as a result of bundle adjustment to/over the pose graph.

Next, the map correction thread according to the second exemplary embodiment will be described.

In step S1205, a loop on the environmental map data that is updated in the map creation thread is detected, and loop closing processing is performed. Details of the loop closing processing are similar to those illustrated in FIG. 10 according to the first exemplary embodiment, except for details of the first correction processing (step S1003). Accordingly, only the details of the first correction processing will now be described.

### (Details of First Correction Processing)

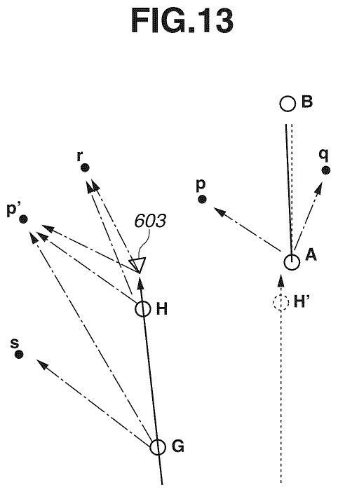

The first correction processing illustrated in step S1003 according to the present exemplary embodiment will be described in detail with reference to FIGS. 13 to 16. In the present exemplary embodiment, in addition to the correction of the position and orientation at each measurement point and the feature point in the environment by rigid transformation using the position/orientation difference, processing for integrating feature points in the environment and bundle adjustment processing using measurement points near the loop source and the loop destination are performed.

Like in the first exemplary embodiment, the second exemplary embodiment also illustrates an example where, as illustrated in FIG. 1, the sensor 603 generates the measurement points B, C, . . . , E, F, G, and H while moving clockwise in the environment from the measurement point A as a start point, and then returns to a position near the measurement point A.

The information processing apparatus 604 calculates the relative position and orientation between measurement points when a loop in which the measurement point H is set as a loop source and the measurement point A is set as a loop destination is detected (step S1001).

FIG. 13 is a diagram illustrating a state of the environmental map in the vicinity of the sensor 603 when a loop is detected. In FIG. 13, black points p, p′, q, r, and s are feature points in the environment. The points p and q are observed from the measurement point A. The point p′ is observed from the measurement points H and G and the latest image of the sensor 603. The point r is observed from the measurement point H and the latest image of the sensor 603. The point s is observed from the measurement point G. The points p and p′ are registered in the environmental map data 701 as different feature points in the environment at this point, but are derived from the same feature point of an object in a real space. Although, in practice, a larger number of feature points are present in the environment for position/orientation estimation, only some of the feature points are illustrated for ease of explanation here.

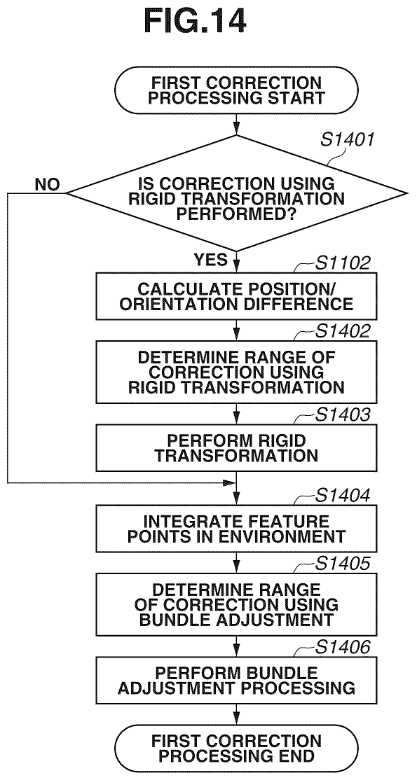

FIG. 14 is a flowchart illustrating a first correction processing flow according to the present exemplary embodiment. As illustrated in FIG. 14, in step S1401, it is determined whether to perform correction processing using rigid transformation. In the present exemplary embodiment, the information processing apparatus 604 executes processing of steps S1102, S1402, and S1403, as long as the feature point in the environment that is observed from the loop destination measurement point is not included in the feature points in the environment that are referred to by the position/orientation calculation unit 703.

In step S1401, it is determined whether correction processing using rigid transformation is performed. If it is determined that correction processing using rigid transformation is performed (YES in step S1401), the processing proceeds to step S1102. Then, in step S1402, the information processing apparatus 604 selects elements on the environmental map data to be corrected by rigid transformation. First, the feature points in the environment that are tracked by the position/orientation calculation unit 703 are extracted. In the example illustrated in FIG. 13, the points p′ and r are extracted. Next, a measurement point at which any one of the feature points is observed is extracted as the measurement point to be corrected. In the example illustrated in FIG. 13, the measurement points H and G are extracted. Lastly, a feature point in the environment that is observed by any one of the measurement points to be corrected is extracted as the feature point in the environment to be corrected. In the example illustrated in FIG. 13, the points p′, r, and s are feature points in the environment to be corrected. The current position/orientation information about the sensor 603 is also corrected. Thus, in this case, the position and orientation at each of the measurement points H and G, the position of each of the feature points p′, r, and s in the environment, and the position and orientation of the sensor 603 are corrected.

In step S1403, the first correction unit 802 adds the position/orientation difference dH calculated in step S1102 to each correction target selected in step S1102, and updates the position and orientation or the position. This processing is rigid transformation, and the relative position/orientation relationship among elements to be corrected is maintained.

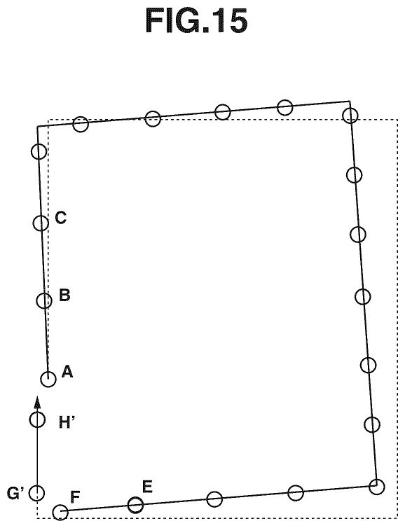

FIG. 15 is a diagram illustrating a positional relationship between measurement points obtained after rigid transformation processing. The position and orientation at each of the measurement points H and G are corrected to H′ and G′, respectively. At this time, the relative position/orientation relationship between the measurement point F and the element to be corrected is collapsed. However, the measurement point and the position/orientation calculation unit 703 do not share the feature points in the environment at this point, and thus the collapse of the relative position/orientation relationship has no adverse effect on the position/orientation calculation.

In step S1404, the first correction unit 802 integrates the feature points in the environment of which the positions are corrected in step S1403 and the feature points in the environment that are present near the corrected positions. First, the information processing apparatus 604 extracts another point located at a certain distance or less from each of the corrected positions in the environmental map from among the feature points in the environment of which the positions are corrected. After that, the information processing apparatus 604 compares images features in the region where the feature point in the environment is observed on the image based on each piece of observation information between the extracted feature points in the environment and the corrected feature points in the environment. Patch matching is used to compare image features. If it is determined that the image features in the observed regions are sufficiently similar to each other, it is determined that the image features indicate the same object in the real space is referred to, and two feature points in the environment are integrated. The method for comparing image features is not limited to this example. For example, an Oriented FAST and Rotated BRIEF (ORB) feature amount may be used.

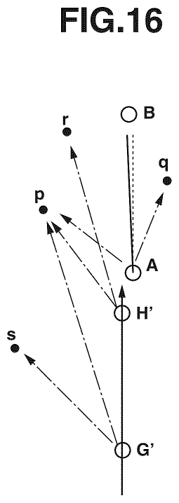

FIG. 16 is a diagram illustrating a state of the environmental map in the vicinity of the sensor 603 after the feature points are integrated. The position of the point p′ is corrected by rigid transformation and then the points p′ and p are integrated. The point p obtained after integration includes observed information about the points p′ and p before integration. In other words, the point p is observed from the measurement points A, H′, and G′.

In step S1405, the first correction unit 802 performs bundle adjustment processing to correct the positions of the feature point group in the environment integrated in step S1404 and the positions and orientations of the measurement point group from which any one of the positions of the feature point group is observed. In the example illustrated in FIG. 13, the feature point p in the environment and the measurement points A, H′, and G′ are points on which bundle adjustment is performed. In reality, a larger number of feature points in the environment that are not illustrated are actually subjected to integration processing and bundle adjustment, and there is sufficient information that can be used to optimize the position and orientation by bundle adjustment. Further, the first correction unit 802 adds or writes the relative position/orientation information between measurements obtained as a result of bundle adjustment to/over the pose graph.

The correction of the position and orientation at each measurement point near the loop source and the loop destination using the bundle adjustment takes a longer time than the correction using rigid transformation but can be completed in a shorter period of time than the processing of step S1004 including the pose graph optimization. Accordingly, after a loop is detected, the loop closing processing unit 705 can obtain the relative position and orientation at each measurement point near the loop source and the loop destination for a short period of time with high accuracy, which leads to an improvement in the accuracy of calculation of the position and orientation by the position/orientation calculation unit 703. The improvement in the accuracy of the position/orientation calculation leads to an improvement in the accuracy of the position/orientation information even when a new measurement point is generated before the second correction processing is completed.

### (Advantageous Effects of the Present Exemplary Embodiment)

According to the present exemplary embodiment described above, even when the environmental map correction processing is executed during creation of environmental map data by the position/orientation calculation method where feature point information in the environment is included in the environmental map data, the environmental map data with which the position/orientation estimation can be achieved with high accuracy can be generated.

### [Other Exemplary Embodiments]

The first and second exemplary embodiments illustrate an example where a camera that is fixed in the front direction of the moving body and configured to acquire grayscale luminance images is used as the sensor 603. However, the type, the number, and the fixing method of the sensor 603 are not limited to this example. Any sensor can be used as the sensor 603, as long as the sensor can successively acquire luminance images or depth images of a surrounding area from the moving body as digital data. Not only a grayscale camera, but also, for example, a camera capable of acquiring color images, a depth camera, a two-dimensional (2D) Light Detection and Ranging (LiDAR) camera, or three-dimensional (3D) LiDAR camera can be used. A stereo camera may also be used, or a plurality of cameras may be arranged in each direction of the moving body. In addition, the number of times at which information id acquired per second is not limited to 30.

For example, in a case where a stereo camera is used as the sensor 603, in step S1201, the information processing apparatus 604 acquires a distance to each image feature point using a stereo image pair, instead of moving the sensor 603 to the position and orientation A′, in the processing for generating a feature point in the environment. The information processing apparatus 604 can transform the distance into three-dimensional coordinates of the image feature point.

Alternatively, in a case where a sensor that can obtain distance information about each pixel of an image, such as a depth camera or 3D-LiDAR, is used as the sensor 603, the information processing apparatus 604 calculates three-dimensional coordinates based on the position and orientation and the angle of view of the sensor and a distance from each pixel. Further, the information processing apparatus 604 may generate a feature point in the environment corresponding to each pixel. In this configuration, a group of feature points in the environment that are denser than that in the second exemplary embodiment can be obtained. In this case, the relative position and orientation between measurement points are calculated using a known Interactive Closest Point (ICP) algorithm. The calculated relative position and orientation can be used for the loop detection processing and the first correction processing.

The first and second exemplary embodiments described above illustrate an example where the position and orientation in a three-dimensional space is measured and environmental map data for use in the position/orientation measurement is created. However, the position/orientation measurement and environmental map data creation may be performed on a two-dimensional plane along a surface on which the moving body moves. For example, in a moving body system that travels on the ground, 2D-LiDAR for scanning data in a horizontal direction may be used as the sensor 603, and environmental map data having a denser feature point group in the environment as described above may be created on the two-dimensional plane.

In the first exemplary embodiment, an image is held as information for loop detection at each measurement point. However, for example, a feature value vector and an image feature point may be calculated based on a BoW model when a measurement point is generated in step S905, and the feature value vector and the image feature point may be held instead of the image. In this case, an image similarity can be calculated based on the feature value vector calculated in advance by the loop detection unit 801, and the relative position and orientation can be calculated based on the feature point calculated in advance.

In the first exemplary embodiment, in step S901, the position of the first measurement point is set as an origin in the environment and the orientation is set in the predetermined direction (e.g., Y-axis positive direction). However, if the position and orientation of the first measurement point can be designated by another method, the value obtained by the method can be used. For example, a relative position and orientation with respect to the sensor 603 may be calculated using a marker that can be detected by the sensor 603 or another unit, and the origin and coordinate axes may be set based on the calculated relative position and orientation. Further, the origin and coordinate axes may be set using a mounting position and orientation of the sensor 603 on the moving body system 601 as an offset.

A marker similar to that described above may be used for loop detection by the loop detection unit 801. For example, by detecting that the same marker is observed from two measurement points instead of calculating an image similarity, the relative position and orientation between images can be calculated based on the relative position and orientation between the sensor and the marker in each image.

The second exemplary embodiment described above illustrates an example where the determination as to whether to execute the rigid transformation processing in step S1401 is made by determining whether the position/orientation calculation unit 703 shares the feature point in the environment with the loop destination measurement point. However, the method for determining whether to execute the rigid transformation processing is not limited to this example. For example, the number of feature points in the environment shared between the position/orientation calculation unit 703 and the loop source measurement point may be compared with the number of feature points in the environment that are shared between the position/orientation calculation unit 703 and the loop destination measurement point, and then it is determined that the rigid transformation processing is executed if the former number is larger than the latter. Alternatively, like in the first exemplary embodiment, it is determined whether the rigid transformation processing is to be executed based on a distance from each measurement point on the pose graph.

While the first exemplary embodiment illustrates an example where a user externally operates the moving body, the configuration of the moving body system 601 is not limited to this example. For example, a manned moving body on which the user boards and can directly operate may be used. Alternatively, a moving body including a function for autonomous traveling along a preset route may be used. In this case, the autonomous traveling can be realized by generating control information for the moving body system 601 based on the environmental map data 701 and position/orientation information calculated by the position/orientation calculation unit 703, and driving the moving units 607 through the control apparatus 606. Further, the moving body system 601 can update the environmental map data 701 according to the method described in the first or second exemplary embodiment based on the sensor information acquired from the sensor 603 during autonomous traveling.

While the exemplary embodiments illustrate a configuration in which the moving units 607 are wheels, a configuration in which a plurality of propellers or the like is mounted on the moving body system 601 and the moving body system 601 flies in the air and the sensor 603 observes in the direction of the ground surface may also be employed.

The present disclosure can also be implemented by processing in which a program for implementing one or more functions according to the above-described exemplary embodiments is supplied to a system or an apparatus via a network or a storage medium, and one or more processors in a computer of the system or the apparatus read out and execute the program. The present disclosure can also be implemented by a circuit (e.g., ASIC) for implementing one or more functions according to the above-described exemplary embodiments.

Processing may be executed using a trained model obtained by machine learning instead of the position/orientation calculation unit 703 and the measurement point generation unit 704 included in the processing units described above. In this case, for example, a plurality of combinations of input data and output data to and from the processing units is prepared as learning data, and a trained model is generated by acquiring knowledge by machine learning such that the trained model outputs the output data corresponding to the input data based on the acquired knowledge as a result. The trained model can be configured using, for example, a neural network model. The trained model operates in cooperation with a CPU or a graphics processing unit (GPU) as a program for performing processing equivalent to the processing units, thereby performing processing corresponding to the processing units. The trained model may be updated after predetermined processing, as needed.

According to the exemplary embodiments of the present disclosure, it is possible to prevent generation of redundant measurement points that is caused by an increase in time for correcting map data during loop closing processing.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

What is claimed is:

1. An information processing apparatus comprising:
a memory storing instructions; and
at least one processor executing the instructions causing the information processing apparatus to function as:
an acquisition unit configured to acquire sensor information obtained by measuring a surrounding environment, the sensor information is obtained using output from a sensor configured to move;
a generation unit configured to generate map data indicating a map based on a movement path of the sensor, the map data including a measurement point where the sensor information is associated with a position and orientation of the sensor;
an estimation unit configured to estimate the position and orientation of the sensor based on the sensor information acquired by the acquisition unit and the measurement point;
a detection unit configured to detect, based on the output from the sensor, a second measurement point that has closed a loop as a result of a first measurement point being revisited;
a first correction unit configured to correct, at a position where the loop is detected, position and orientation information of one or more third measurement points used by the estimation unit to estimate the position and orientation, by using a difference between position and orientation information of the second measurement point before aligning with the first measurement point, and position and orientation information of the second measurement point after aligning with the first measurement point; and
a second correction unit configured to correct, after position and orientation information of the third measurement points have been corrected by the first correction unit, position and orientation information associated with a plurality of measurement points different from the third measurement points,
wherein, in response to the detection unit detecting that the loop has been closed, the generation unit is configured to refrain from generating a new measurement point during a period from detection of the loop until completion of the correction by the first correction unit.

2. The information processing apparatus according to claim 1, wherein, in a case where a loop is detected by the detection unit, the generation unit does not generate a new measurement point until the correction by the first correction unit is completed.

3. The information processing apparatus according to claim 1, wherein the first correction unit corrects the position and orientation using rigid transformation.

4. The information processing apparatus according to claim 1, wherein the first correction unit calculates a position and orientation at the second measurement point after correction based on a relative position and orientation between the position and orientation at the second measurement point and the position and orientation at the first measurement point.

5. The information processing apparatus according to claim 4, wherein the first correction unit adds a difference in position and orientation calculated based on the position and orientation at the second measurement point before correction and the position and orientation corresponding to the second measurement point after correction to a position and orientation at a third measurement point to correct the position and orientation at the third measurement point.

6. The information processing apparatus according to claim 1,
wherein the map data generated by the generation unit includes position information about a feature point in the surrounding environment,
wherein the measurement point includes information about the feature point observed based on the sensor information at the measurement point, and
wherein the estimation unit estimates the position and orientation of the sensor based on the feature point.

7. The information processing apparatus according to claim 6,
wherein the second measurement point is one or more measurement points at which the feature point used for the estimation by the estimation unit is observed, and
wherein the first correction unit further corrects a position of the feature point.

8. The information processing apparatus according to claim 7, wherein the first correction unit integrates a first feature point and a second feature point in a case where the first feature point of which a position is corrected and the second feature point included in the map data are located within a predetermined distance and a feature of the first feature point observed based on the sensor information is similar to a feature of the second feature point observed based on the sensor information.

9. The information processing apparatus according to claim 8, wherein the first correction unit corrects the position and orientation by performing bundle adjustment on the integrated feature point and the measurement point where the integrated feature point is observed.

10. The information processing apparatus according to claim 1, wherein the first correction unit performs correction depending on a distance between the second measurement point and the first measurement point.

11. The information processing apparatus according to claim 1,
wherein the map data includes a pose graph including a relative position and orientation between measurement points, and
wherein the second correction unit corrects the positions and orientations at the plurality of measurement points to minimize an error in the relative position and orientation calculated based on the relative position and orientation between measurement points illustrated in the pose graph and the positions and orientations at the plurality of measurement points.

12. The information processing apparatus according to claim 1,
wherein the sensor is a camera, and
wherein the sensor information is an image.

13. The information processing apparatus according to claim 1, wherein the detection unit detects a loop in a case where an object observed based on the sensor information associated with the first measurement point is output from the sensor that has moved and is observed based on the sensor information acquired by the acquisition unit.

14. The information processing apparatus according to claim 1, further comprising:
the sensor; and
a moving unit.

15. The information processing apparatus according to claim 14, wherein the moving unit moves based on an operation by a user.

16. The information processing apparatus according to claim 14, wherein the moving unit moves along a preset route based on the position and orientation estimated by the estimation unit.

17. The information processing apparatus according to claim 14, wherein the moving unit is a wheel or a propeller.

18. The information processing apparatus according to claim 1, wherein the correction by the first correction unit is executed before the correction by the second correction unit is executed.

19. An information processing method comprising:
acquiring sensor information obtained by measuring a surrounding environment, the sensor information is obtained using output from a sensor configured to move;
generating map data indicating a map based on a movement path of the sensor, the map data including a measurement point where the sensor information is associated with a position and orientation of the sensor;
estimating the position and orientation of the sensor based on the acquired sensor information and the measurement point;
detecting, based on the output from the sensor, a second measurement point that has closed a loop as a result of a first measurement point being revisited;
correcting, at a position where the loop is detected, position and orientation information of one or more third measurement points used to estimate the position and orientation, by using a difference between position and orientation information of the second measurement point before aligning with the first measurement point, and position and orientation information of the second measurement point after aligning with the first measurement point; and
correcting, after position and orientation information of the third measurement points have been corrected by the first correction, position and orientation information associated with a plurality of measurement points different from the third measurement points,
wherein, in response to detecting that the loop has been closed, the generation unit is configured to refrain from generating a new measurement point during a period from detection of the loop until completion of the correction by the first correction unit.

20. A non-transitory storage medium storing a program for causing a computer to execute an information processing method, the method comprising:
acquiring sensor information obtained by measuring a surrounding environment, the sensor information is obtained using output from a sensor configured to move;
generating map data indicating a map based on a movement path of the sensor, the map data including a measurement point where the sensor information is associated with a position and orientation of the sensor;
estimating the position and orientation of the sensor based on the acquired sensor information and the measurement point;
detecting, based on the output from the sensor, a second measurement point that has closed a loop as a result of a first measurement point being revisited;
correcting, at a position where the loop is detected, position and orientation information of one or more third measurement points used to estimate the position and orientation, by using a difference between position and orientation information of the second measurement point before aligning with the first measurement point, and position and orientation information of the second measurement point after aligning with the first measurement point; and
correcting, after position and orientation information of the third measurement points have been corrected by the first correction, position and orientation information associated with a plurality of measurement points different from the third measurement points,
wherein, in response to detecting that the loop has been closed, the generation unit is configured to refrain from generating a new measurement point during a period from detection of the loop until completion of the correction by the first correction unit.
